(19) United States
(12) Patent Application Publication
(10) Pub. No.: US 2015/0350615 A1
(43) Pub. Date: Dec. 3, 2015

(54) PROJECTOR SYSTEM

(71) Applicant: Panasonic Intellectual Property Management Co., Ltd., Osaka (JP)

(72) Inventor: Keigo ONO, Osaka (JP)

(21) Appl. No.: 14/724,389

(22) Filed: May 28, 2015

(30) Foreign Application Priority Data
May 29, 2014 (JP) 2014-110900
Mar. 11, 2015 (JP) 2015-048655

(51) Int. Cl. H04N 9/31; G06T 7/20; G06T 7/00

(52) U.S. Cl. CPC H04N 9/3135; H04N 9/3188; H04N 9/3185; H04N 9/3194; G06T 7/0081; G06T 7/004; G06T 7/0018; G06T 7/2073; G06T 2207/10028; G06T 2207/10148; G06T 2207/20068; G06T 2207/20201; G06T 2210/61

(57) ABSTRACT

A projector system includes an image acquiring unit configured to temporally and continuously capture an image of a region including the projection plane to generate image information, and a controller configured to calculate distance information as information on distance to the projection plane based on the image information generated by the image acquiring unit and performs predetermined control by using the calculated distance information, and updates the distance information used for the predetermined control at predetermined timing. Regarding update of the distance information, the controller calculates information on movement of an object included in the image information. When determining that the object is not moving, the controller updates the currently set distance information with newly acquired distance information, while when determining that the object is moving, the controller maintains the currently set distance information as it is without updating the currently set distance information.

### BACKGROUND

1. Technical Filed

The present disclosure relates to a projector system for executing a predetermined process based on information on distance between the projector system and an object to which an image is projected by the projector system.

2. Related Art

Japanese Laid-Open Patent Publication No. 2013-33206 discloses a projection display device including an image light projecting unit projecting image light on a screen, a distance measuring unit measuring a distance to the screen, an obstacle detecting unit detecting an obstacle between the screen and the image light projecting unit based on the distance information acquired by the distance measuring unit and determining an adjustment region of the image light to be projected depending on a result of the detection, and a projection adjusting unit adjusting the image light in the adjustment region. This projection display device including the configuration described above measures a distance to the screen as a projection plane, detects an obstacle from the measurement result, and adjusts projection on the basis of a region including the detected obstacle, thereby providing a highly accurate and effective antiglare function.

### SUMMARY

The present disclosure provides a projector system capable of accurately acquiring distance information indicative of distance to a projection plane.

In one aspect of this disclosure, a projector system includes a projector unit configured to project an image on a projection plane, an image acquiring unit configured to temporally-continuously capture an image of a region including the projection plane to generate image information, and a controller configured to calculate distance information that is information on distance to the projection plane based on the image information generated by the image acquiring unit and performs predetermined control by using the calculated distance information, the controller updating the distance information used for the predetermined control at predetermined timing. With regard to update of the distance information, the controller calculates information on movement of an object included in the image information from the image acquiring unit to determine movement of the object based on the information on movement. When it is determined that the object is not moving, the controller updates the currently set distance information with newly acquired distance information. When it is determined that the object is moving, the controller maintains the currently set distance information as it is without updating the currently set distance information.

According to the present disclosure, the projector system switches update/non-update of the information on distance to the projection plane depending on a detection result of movement of the object in a distance measurement region. As a result, for example, when it is considered that the distance to the projection plane cannot accurately be measured such as when a user is performing an operation to a projected user interface image, the distance information is not updated. Therefore, the projector system can accurately acquire the distance information of the projection information.

### BRIEF DESCRIPTION OF DRAWINGS

FIG. 1 is a configuration diagram of a projector system of an embodiment;

FIG. 2 is a diagram for explaining a user operation to a user interface (UI) image projected on a projection plane;

FIG. 3 is a flowchart for showing an operation of updating of distance information on distance to the projection plane in the embodiment;

FIG. 4 is a diagram for explaining a measurement target range in the distance information;

FIG. 5 is a flowchart for showing an operation for waiting stabilization upon startup of a distance sensor in this embodiment;

FIG. 6 is a flowchart for showing a control of suppressing measurement variation of the distance sensor in this embodiment;

FIG. 7 is a flowchart for showing a control of limitation for an area in which data is acquired from the distance sensor in this embodiment; and

FIG. 8 is a flowchart for showing a control of detection for a point at which distance cannot stably be measured in the embodiment.

### DETAILED DESCRIPTION OF EMBODIMENTS

Embodiments will now be described in detail with reference to the drawings as needed. It is noted that detailed description will not be provided more than necessary in some cases. For example, detailed description of already well-known facts and repeated description of substantially the same constituent elements may not be provided. This is for the purpose of avoiding unnecessary redundancy of the following description and facilitating understanding by those skilled in the art.

The inventor (s) provides the accompanying drawings and the following description for sufficient understanding of this disclosure by those skilled in the art and it is not intended to limit the subject matter described in the claims thereto.

### First Embodiment

A first embodiment will hereinafter be described with reference to the accompanying drawings.

A conventional projector system measures distance from a device thereof to a projection plane in an initialization process at the time of activation and retains distance information on the measured distance in a storage device. The distance information is used in the subsequent various processes (various operations such as a focus operation). Since the distance to the projection plane can be determined by one initialization process in this method, this method is advantageous in that a load can be reduced in terms of the projector system. However, a problem exists that the projector system cannot deal with the case when the distance to the projection plane is changed after the activation of the projector system. The projector system also has a restriction that an object must not be located between the projector system and the projection plane during the initialization process in which the distance to the projection plane is measured.

With regard to such problems, a projector system of the present embodiment captures an image of a region including at least a projection plane at predetermined timing. The projector system calculates information on movement of an object included in the captured region from a captured image, and determines whether the object is moving or not, based on the calculated information on movement. When it is determined that the object is moving (in other words, when a moving object is detected), the projector system uses information on distance to the projection plane currently stored in a storage device and stops update of the information on distance to the projection plane. On the other hand, when it is determined that the object is not moving (in other words, when no moving object is detected), the projector system updates the information on distance to the projection plane in the storage device with information on the lastly measured distance.

With such control, the information on distance from the projector system to the projection plane can be updated as needed depending on a change of a state in a region including the projection plane. For example, if an image of a user interface (UI) is projected on the projection plane, it can be determined whether a user is operating the UI so as to update the information on distance from the device to the projection plane. Alternatively, it can be determined whether a change occurs in the projection plane so as to update the information on distance from the device to the projection plane. The change in the projection plane in this case includes a state that the shape of the projection plane is changed, a state that an object is placed between the projection plane and the projector system, and so on.

The projector system of this embodiment will hereinafter be described with reference to the drawings.

### 1. Configuration of Projector System

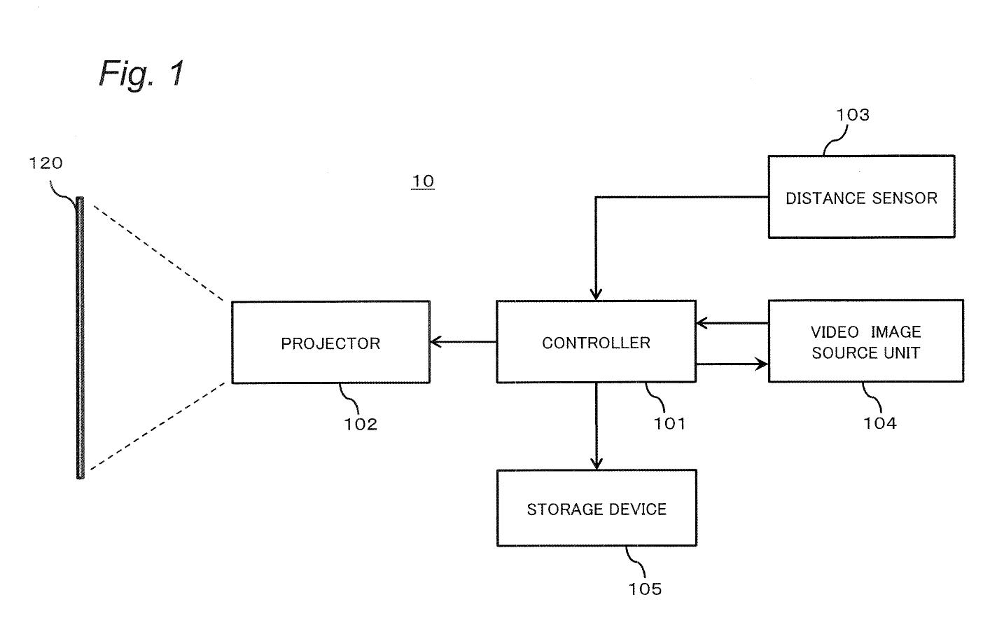

FIG. 1 is a configuration diagram of a projector system 10 of the present embodiment.

The projector system of the present embodiment includes a controller 101, a projector 102, a distance sensor 103, a video image source unit 104, and a storage device 105.

The distance sensor 103 (an example of an image acquiring unit) measures a distance of an object disposed in a region including a projection plane 120 on which the projector 102 projects an image light. In particular, the distance sensor 103 captures an image of a region including an object for which distance should be measured, and measures distance from the distance sensor 103 to the object based on the captured image. The distance sensor 103 outputs information on the measured distance (hereinafter referred to as “distance information”) to the controller 101. The distance information may be information indicative of distance to all the positions (two-dimensionally arranged measurement points) projected in the region including the projection plane 120 or may be information indicative of distance to some predetermined positions (measurement points) in the region. Therefore, the distance sensor 103 two-dimensionally measures the distance to the measurement points included in the region including the projection plane 120. The distance sensor 103 outputs, as a measurement result, the distance information (distance image) having pixels corresponding to the measurement points.

The distance sensor 103 may have any configuration (method) having a function for capturing an image of a region including the projection plane 120 on which the projector 102 projects an image and for outputting information indicative of distance of an object disposed in the region as image information. For example, the distance sensor 103 may have a configuration including two cameras capable of taking color images to implement a stereo camera method of measuring distance with the trigonometry. Alternatively, the distance sensor 103 may have a configuration for projecting a random dot pattern with infrared light to capture an image of the pattern with an infrared camera and calculating distance with the trigonometry. The distance sensor 103 can be made up of a TOF (time-of-flight) sensor. The TOF sensor is a sensor emitting infrared light, receiving reflected light of the emitted infrared light with an infrared camera, and calculating distance of two-dimensionally arranged measurement points from a phase difference between the emitted infrared light and the received reflected light to output the distance information (distance image) based on the calculated distance.

The video image source unit 104 includes a recording medium such as an HDD, an optical disk, a semiconductor storage device, and a memory, and is made up of a circuit reading a video signal stored in the recording medium to output the read video signal to the controller 101. Alternatively, the video image source unit 104 may be configured to input a video signal from the outside to output the input video signal to the controller 101. The video image source unit 104 can switch and execute transmission of a compressed video signal and transmission of uncompressed video signal in accordance with a transmission format of connection to the controller 101. In short, the video image source unit 104 may have any configuration capable of outputting the video signal to the controller 101 regardless of whether the signal is compressed or uncompressed.

The storage device 105 is a device storing data and can be made up of, for example, a semiconductor storage device such as a flash memory, a DRAM, an SRAM, and an SSD, a hard disk, or an optical disk device. The storage device 105 stores the distance information indicative of distance to the projection plane measured by the distance sensor 103.

The controller 101 controls the overall operation of the projector system 10 of the present embodiment. The controller 101 acquires a video signal from the video image source unit 104 and outputs the acquired video signal to the projector 102. In this case, the controller 101 may execute a predetermined image process, for example, geometric correction, to the acquired video signal and then outputs the processed video signal.

The controller 101 may have any configuration having a function of controlling the operation of the entire projector system. For example, the controller 101 can be made up of a microcomputer, CPU, MPU, or the like which is capable of executing software (program). By using a microcomputer capable of executing software, process to be executed can be changed by changing the software and, therefore, a degree of freedom can be increased in design of the controller. Alternatively, the controller 101 can be achieved by hard logic (such as a hardware circuit, ASIC, FPGA, and DSP). The controller 101 which is implemented by hard logic can improve a processing speed.

The projector 102 includes a light source (such as an TED light-emitting element), a display modulation element (such as LCD and DMD), and an optical system (such as a lens, a mirror, and a prism) and inputs a video signal from the controller 101 to project image light based on the video signal onto the predetermined projection plane 120. The projector 102 may have any configuration having a function of projecting an image indicated by the input video signal.

### 2. Function and Operation of Projector System

A specific function processed by the controller 101 of the projector system 10 will be described below. The controller 101 performs the following functions by controlling the distance sensor 103 or based on the distance information from the distance sensor 103:

(1) an update function of determining update/non-update of distance information indicative of distance to the projection plane 120 based on a measurement result from the distance sensor 103;

(2) a waiting control function of waiting until stabilization of output of the distance sensor 103 at the time of activation of the projector system 10;

(3) a correction function of correcting an error of the distance information from the distance sensor 103;

(4) a limiting function of limiting a range of the measurement by the distance sensor 103; and

(5) a detection function of detecting and invalidating a point that cannot stably be measured by the distance sensor 103.

Each of the five functions performed by the controller 101 will hereinafter be described with reference to the drawings.

(1) Update Function of Determining Update/Non-Update of Distance Information to Projection Plane Based on Measurement Result from the Distance Sensor 103

A system enabling an interactive touch operation to an image such as a projected UI (user interface) must measure a distance L0 from a device (the distance sensor 103) projecting an image to the projection plane 120 on which the image is projected, so as to detect the touch operation.

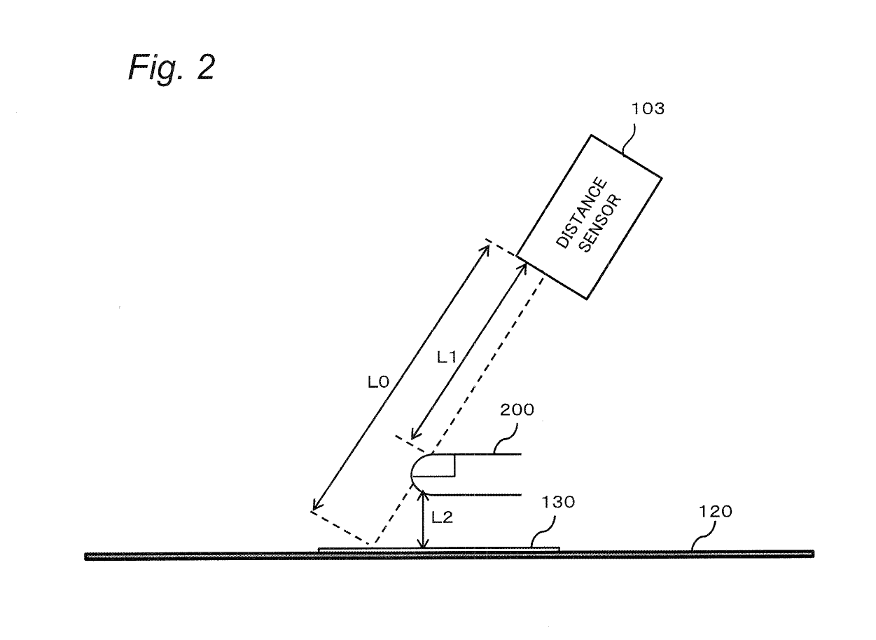

For example, as shown in FIG. 2, when a UI (user interface) image 130 is projected on the projection plane 120, the distance L0 from the distance sensor 103 (a device projecting an image) to the projection plane 120 is measured in advance. A user brings a finger 200 closer to the UI image 130 for operating the projected UI image 130. In this case, the distance sensor 103 measures a distance L1 to the finger 200. The controller 101 calculates a distance L2 from the projection plane 120 to the finger 200 based on the distance L0 to the projection plane 120 and the distance L1 to the finger 200. When the calculated distance L2 is equal to or less than a predetermined value, the controller 101 determines that the touch operation is performed and executes a process corresponding to the UI image. As described above, a reference is made to the distance L0 to the projection plane 120 in the determination of the presence/absence of the touch operation to the projected UI image. Therefore, it is important to always recognize the distance L0 to the projection plane 120 accurately. Conventionally, the distance to the projection plane is typically measured at the time of activation of the device. However, in some use cases, the distance from the device projecting an image to the projection plane having the image projected thereon may be changed after the activation.

Therefore, in this embodiment, the distance information indicative of the distance to the projection plane 120 is periodically updated. Particularly, in an update process of the distance information, movement of an object located between the projection plane 120 and the distance sensor 103 is detected, and then update/non-update of the distance information indicative of the distance from the device projecting an image to the projection plane 120 is determined in accordance with the detection result. Such control enables acquisition (recognition) of the accurate distance information on the distance to the projection plane 120.

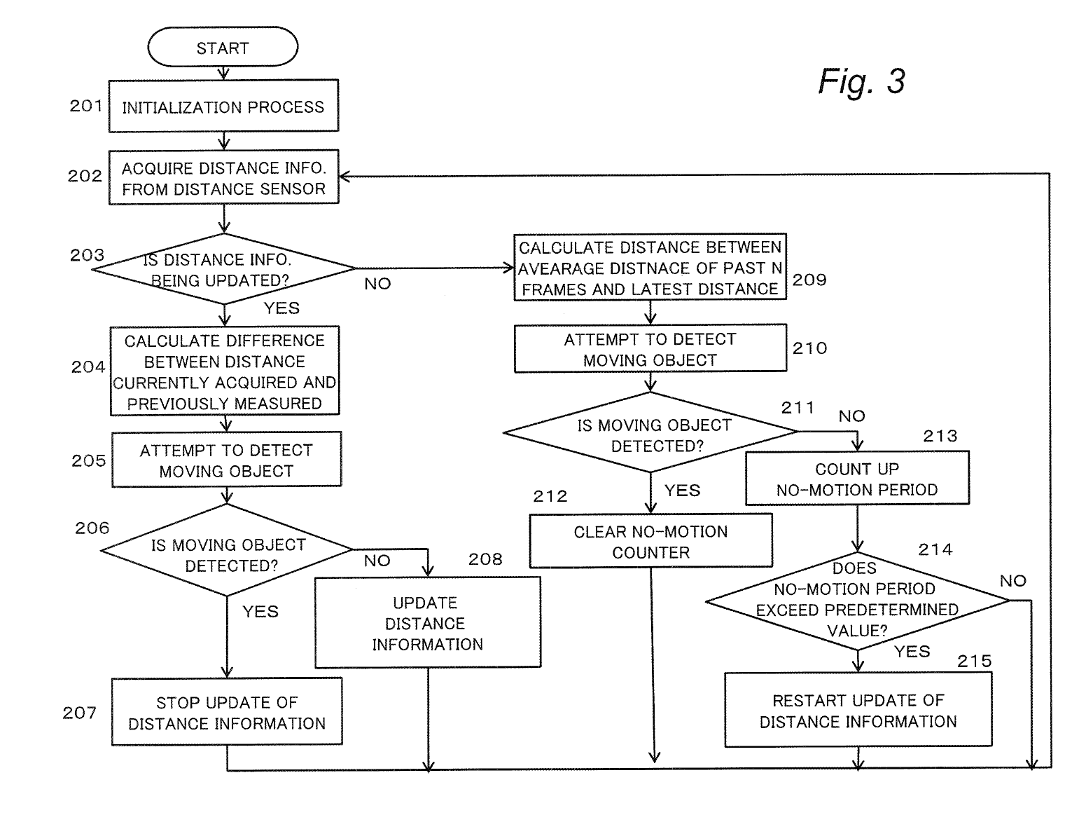

FIG. 3 is a flowchart for explaining an update operation of the distance information indicative of distance from the distance sensor 103 to the projection plane 120 by the projector system 10 of the present embodiment.

When the projector system 10 is activated (started up), the controller 101 first executes an initialization process (S201).

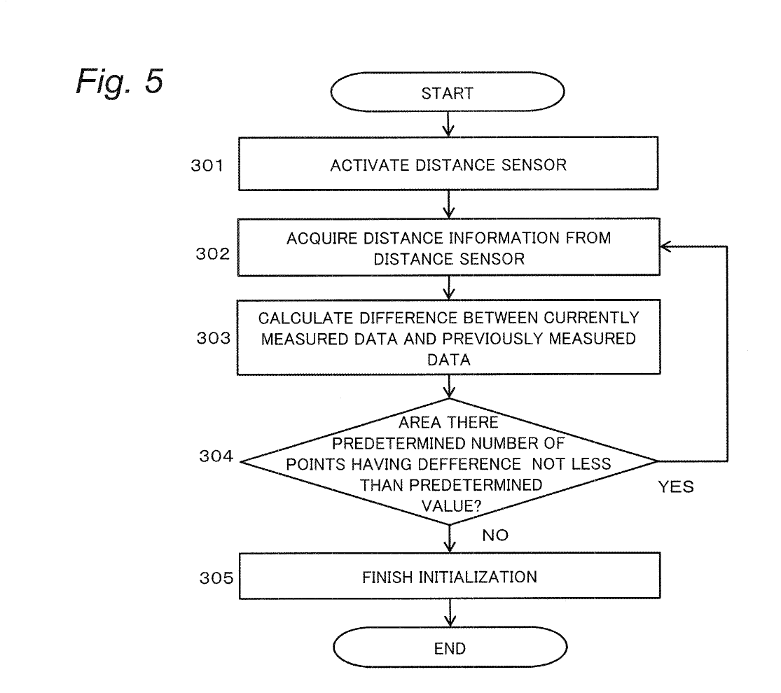

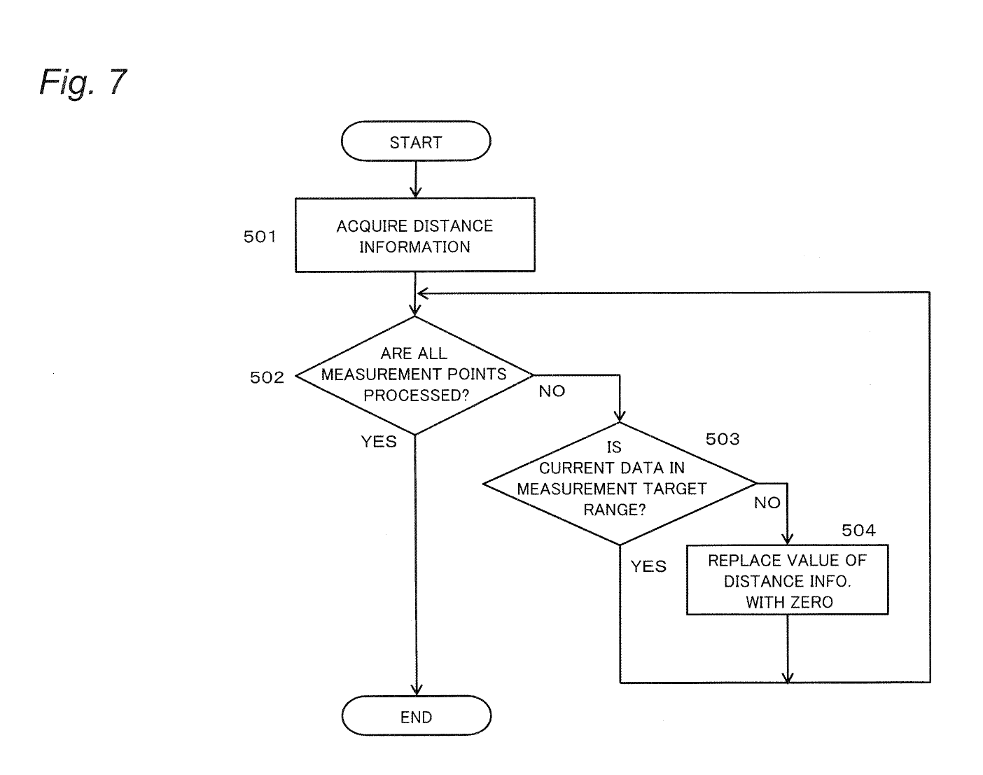

During the initialization process, the controller 101 performs the waiting control function of stopping the output of the distance sensor 103 until the output of the distance sensor 103 becomes stable (described later in detail with reference to FIG. 5) and the limiting function of limiting a range of the measurement by the distance sensor 103 (described later in detail with reference to FIG. 7). The controller 101 acquires an initial value of the distance information indicative of the distance to the projection plane 120. The initial value of the distance information is not the distance information acquired from the distance sensor 103 and is a value preset arbitrarily.

As described above, the distance sensor 103 measures distance for each of the measurement points (pixels) arranged two-dimensionally in a measurement target region including the projection plane 120. However, in the following description, the controller 101 executes a process by using distance information measured in a limited range (i.e., a partial region) in the entire measurable region in the described operation. The partial region is a region in which an image is projected that indicates an object to be operated by a user, such as icons and buttons, for example. The limiting function of limiting a range of the measurement by the distance sensor 103 to a partial region may not necessarily be performed in the initialization process (step S201) or this function may be skipped.

After the initialization process (S201), the controller 101 acquires actual distance information indicative of a result of measurement by the distance sensor 103 from the distance sensor 103 (S202). In this time, the controller 101 may also perform the correction function of correcting an error of information on the distance acquired from measurement by the distance sensor 103 and the detection function of detecting a point that cannot stably be measured by the distance sensor 103. The operations of these two functions can selectively be switched on/off (performed/not performed) as needed.

The controller 101 determines whether the distance information indicative of distance to the projection plane is being updated (S203). This determination can be made by preliminarily setting an update flag indicative of whether the distance information is being updated and by referring to the update flag. It is assumed that the update flag is set to a value indicative of “being updated” by default. The controller goes to step S204 if it is determined that the distance information is being updated, or goes to step S209 if it is determined that the distance information is not being updated.

Description will be made of the process when the controller 101 determines that the distance information is being updated.

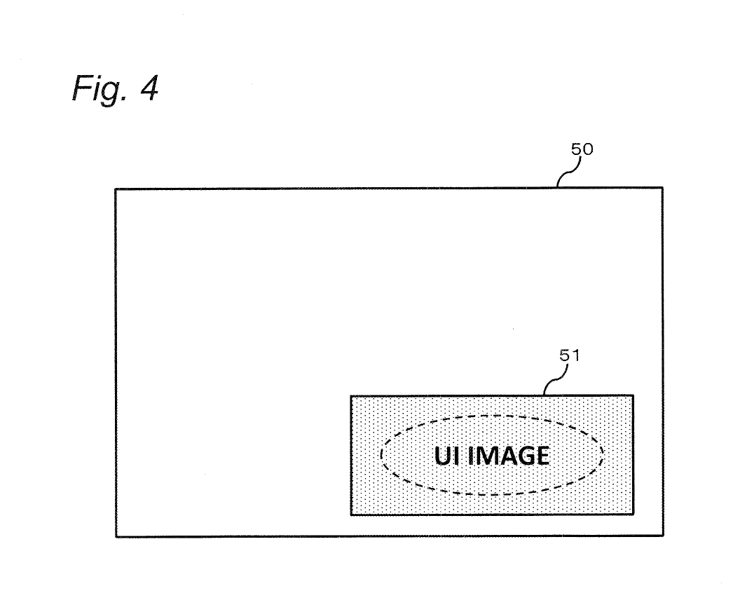

When it is determined that the distance information is being updated (YES at step S203), the controller 101 calculates a difference between the distance information acquired at step S202 and the distance information to the projection plane 120 determined in the previous process (S204). For example, a difference is obtained for each pixel (measurement point) in the distance information (distance image), and a value acquired by summing the obtained differences is used as a value of the difference. If the difference of the distance information is calculated for the first time after activation, the initial value of the distance information acquired in the initialization process (step S201) is used as the distance information to the projection plane 120 determined in the previous process. In this case, the difference of the distance information is calculated only in a partial limited range (hereinafter a “measurement target range”) in a measurable range. The measurement target range is a partial range 51 in an entire range 50 that can be measured by the distance sensor 103 as shown in FIG. 4. For example, the measurement target range is set to the range 51 including a range in which a UI image for operation by a user is displayed and an adjacent range necessary for detecting the user operation to the UI image (described later in detail).

The controller 101 determines whether a moving object (target) is present in the measurement target range of the distance sensor 103 based on the difference calculated at step S204 (S205).

To determine whether a moving object is present, for example, the controller 101 determines whether the value of the difference calculated at step S204 is equal to or greater than a predetermined value. When the value of the calculated difference is equal to or greater than a predetermined value, the controller 101 determines that a moving object is present between the projection plane 120 and the distance sensor 103.

The controller 101 switches the subsequent process based on the determination result (S206). Specifically, when determining that a moving object is present between the projection plane 120 and the distance sensor 103, the controller 101 goes to step S207. On the other hand, when determining that no moving object is present between the projection plane 120 and the distance sensor 103, the controller 101 goes to step S208.

In the example described above, the detection of a moving object is made based on the difference of the distance information. However, for example, if an imaging device is connected to the controller 101, the controller 101 may detect the moving object based on an image signal acquired from this imaging device. In this case, a moving object can be detected based on a value of difference in image signals between temporally-continuously captured images (i.e., for each frame).

When it is determined that a moving object is present between the projection plane 120 and the distance sensor 103 (YES at S206), the controller 101 stops the update process of the distance information indicative of the distance to the projection plane 120 (S207). In particular, the controller 101 sets the update flag to a value indicative of “stop”.

On the other hand, when it is determined that no moving object is present between the projection plane 120 of the projector 102 and the distance sensor 103 (NO at S206), the controller 101 updates the distance information indicative of the distance to the projection plane 120 in the storage device 105 to the latest value (S208).

For the distance information used for the update described above, the distance information acquired at step S202 may be used, or information acquired by modifying the distance information acquired at step S202 may be used. The information acquired by modifying the distance information is, for example, an average value of the distance information corresponding to past N frames (N is a predetermined natural number) from the latest frame.

The description has been made of the control when the controller 101 determines that the distance information is being updated at step S203. Description will be made of the process when it is determined that the distance information is not being updated at step S203.

When it is determined that the distance information is not being updated (NO at S203), the controller 101 calculates a difference between distance information of an average of past N frames from the current time point and a value indicative of distance information acquired at the current time point (the distance information acquired at step S202) (S209). The value of N is determined depending on an update frame rate of the distance sensor 103. Therefore, N is a value set appropriately depending on performance of a device composing the distance sensor 103.

The controller 101 determines whether a moving object is present between the projection plane 120 and the distance sensor 103 based on the difference calculated at step S209 (S210). For example, the controller 101 makes the determination based on whether the value of the difference extracted at step S209 is equal to or greater than a predetermined value. If the difference is equal to or greater than the predetermined value, it is determined that a moving object is present between the projection plane 120 and the distance sensor 103. In this case, it is considered that an object (e.g., a portion of the user's body) has entered between the projection plane 120 and the distance sensor 103. On the other hand, if the difference is less than the predetermined value, it is determined that no moving object is present. In this case, it is considered that an object (e.g., a portion of the user's body) has not entered between the projection plane 120 and the distance sensor 103. Although the presence of a moving object is determined based on whether the difference is equal to or greater than a predetermined value in the operation described above, for example, two threshold values may be provided to make the determination. Specifically, it may be determined that no moving object is present (in other words, no object has entered) between the projection plane 120 and the distance sensor 103 if the difference is smaller than a first threshold value and it may be determined that a moving object is present (in other words, an object has entered) between the projection plane 120 and the distance sensor 103 if the difference is equal to or greater than a second threshold value larger than the first threshold value.

If a moving object is detected (YES at S211), the controller 101 resets (clears) a count value indicative of a period without a moving object between the projection plane 120 and the distance sensor 103 to zero (S212). The controller 101 has an internal memory and the count value is written to this internal memory. When determining that a moving object is present between the projection plane of the projector 102 and the distance sensor 103, the controller 101 clears the count value to zero in this way.

After the process of step S212, the controller 101 returns to step S202.

If it is determined that no moving object is present between the projection plane 120 and the distance sensor 103 (NO at step S211), the controller 101 counts up the count value stored in the internal memory (S213).

The controller 101 determines whether the count value exceeds a predetermined threshold value (S214). The threshold value is determined depending on an update frame rate of the selected distance sensor 103. Therefore, preferably, the threshold value is appropriately set depending on the selected distance sensor 103.

If the count value is equal to or less than the threshold value (NO at S214), it cannot be determined in this state whether a portion of the user's body is standing still or the object (a portion of the user's body) is no longer present between the projection plane 120 and the distance sensor 103. Therefore, the controller 101 returns to step S202 to continue the above operation again.

On the other hand, if the count value is equal to or greater than the threshold value (YES at S214), it can be determined that the object (a portion of the user's body) is no longer present between the projection plane 120 and the distance sensor 103. Therefore, the controller 101 resumes the update of the distance information indicative of the distance to the projection plane 120 (S215). In particular, the controller 101 updates the distance information indicative of the distance to the projection plane 120 to the latest value, sets the update flag to a value indicative of “being updated”, and goes to step S202.

By providing the control as described above, the update of the distance information indicative of the distance to the projection plane 120 can be switched depending on whether a moving object is present between the projection plane 120 and the distance sensor 103.

When a moving object such a user's finger is present between the projection plane 120 and the distance sensor 103, the measured distance may not be the accurate distance from the distance sensor 103 to the projection plane 120. Therefore, in this embodiment, the distance information indicative of the distance to the projection plane 120 is updated only when no moving object is present between the projection plane 120 and the distance sensor 103. As a result, the distance information indicative of the accurate distance to the projection plane 120 is always regained and the accuracy can be improved in the process using the distance information.

For example, it is assumed that the projector system 10 projects a picture (UI image) indicative of a user inter face such as a keyboard and an icon while a user touches the projected picture with a finger to perform an operation. According to the projector system of this embodiment, the distance information indicative of the distance to the projection plane 120 is not updated while the user is operating the projected UI image and the distance information is updated when the user is not operating the UI image. This can prevent the projector system from wrongly measuring the distance to the user's finger as the distance to the projection plane and updating the distance information with a wrong measurement value. Thus, the controller 101 can accurately comprehend the distance to the projection plane without effect of the operation being performed by the user and therefore can accurately comprehend the distance from the user's finger to the projection plane 120 based on the distance to the projection plane to enable accurate detection of the touch operation.

Since the condition of the projection plane 120 itself can highly accurately be comprehended in this embodiment, the accuracy of touch operation can be improved on any surfaces on which projection is performed. Any surfaces include a projection plane newly set by moving the projector 120 or by moving the projection plane 120 and a surface of an object newly placed between the projector 102 and the projection plane 120. Even if a portion of the user's body falls within the angle of view of projection of the projector 102, the touch operation can be performed without causing malfunction.

### (2) Waiting Control Function

The waiting control function of the distance sensor 103 performed in the initialization process (S201) will be described. The waiting control function is a function of waiting for activation of the distance sensor 103 until the distance sensor 103 outputs stable output after the activation.

A typical distance sensor may output inaccurate distance information immediately after activation depending on device characteristics. In this case, if unstable data immediately after activation is directly used, trouble such as malfunction may occur. A conceivable method of avoiding the malfunction is to employ the output of the distance sensor after a certain period has elapsed from the activation until the output distance information becomes stable. However, the period until stabilization may differ depending on a distance sensor and the waiting time must be switched depending on a selected sensor.

Therefore, in this embodiment, the waiting time is varied depending on variation of information output by the distance sensor 103 (a difference between previous and current pieces of the distance information). With such control, the waiting time until stabilization of the operation of the distance sensor 103 can be varied depending on device characteristics and the waiting time can properly be set.

FIG. 5 is a flowchart for explaining the waiting control function.

The controller 101 activates the distance sensor 103 (S301). This activation process for the distance sensor 103 may be executed in conjunction with the activation of the whole projector system 10. In the activation process of the distance sensor 103, the controller 101 executes a predetermined initialization process for the distance sensor 103.

When the initialization process of the distance sensor 103 is completed, the controller 101 acquires the distance information (distance measurement data) from the distance sensor 103 (S302).

The controller 101 calculates a difference between distance information acquired in the past and distance information acquired at the current time out of the distance information acquired from the distance sensor 103 for each of predetermined points (measurement points) (S303). For example, in the case of the configuration in which the distance information can be obtained from each of the regions acquired by diving the entire region of the projection plane into nine pieces, the controller 101 calculates a difference for a predetermined number of the measurement points included in each of the divided regions. The distance sensor 103 calculates a difference in units of the distance information that can be acquired by the distance sensor 103.

The controller 101 determines whether the number of the measurement points having the calculated difference equal to or greater than a predetermined value is equal to or greater than a predetermined number (n points) (S304). If the number of the measurement points having the difference equal to or greater than a predetermined value is equal to or greater than the predetermined number (n points) (YES at S304), it can be determined that the distance information (measurement data) from the distance sensor 103 is not stable. In this case, the controller 101 returns to step S302 and waits until the output from the distance sensor 103 becomes stable.

On the other hand, if the number of the measurement points having the difference equal to or greater than a predetermined value is less than the predetermined number (n points) (NO at S304), it can be determined that the distance information (measurement data) from the distance sensor 103 is stable. Therefore, in this case, the controller 101 completes the initialization operation of the distance sensor 103 of the distance sensor 103 (S305). This leads to the termination of the waiting control.

By executing the stabilization waiting process of the output of the distance sensor 103 as described above, the time (waiting time) can be made variable until variation becomes small in the distance information output from the distance sensor 103 immediately after the activation of the distance sensor 103. The initialization of the distance sensor 103 is not allowed to be completed until the stable distance information is output from the distance sensor 103. As a result, the output from the distance sensor 103 becomes stable and highly reliable and the malfunction can be suppressed when a process is executed by using the distance information.

### (3) Distance Information Error Correction Function

The correction function of correcting an error of the distance information output from the distance sensor 103 will hereinafter be described with reference to the drawings.

The distance information measured by the distance sensor 103 generally includes certain variations. Therefore, if the distance information is directly used, a malfunction unintended by a user may occur.

Therefore, the controller 101 of this embodiment does not directly use the distance information acquired from the distance sensor 103 and uses the distance information after correction.

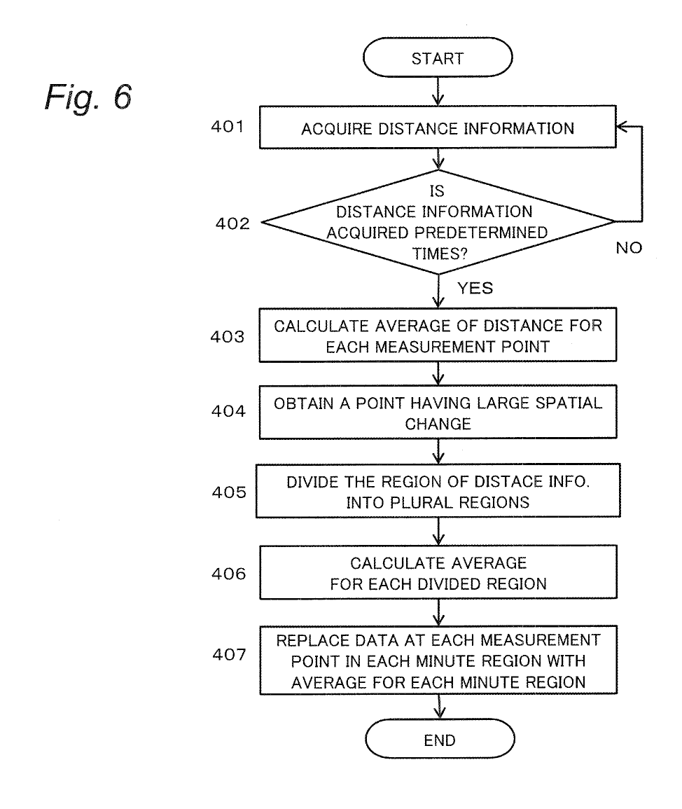

FIG. 6 is a flowchart for explaining the correction function of suppressing the measurement variations of the distance sensor in this embodiment.

The controller 101 acquires the distance information (distance measurement data) measured by the distance sensor 103 (S401). In this case, unlike step S202 or S302 described above, the distance information acquired from the distance sensor 103 is directly used for the subsequent control.

The controller 101 determines whether the distance information is acquired a predetermined number of times (e.g., ten times) or more from the distance sensor 103 (S402). For example, if the distance sensor 103 measures distance at sampling intervals of 100 ms, the controller 101 acquires the distance information from the distance sensor 103 ten times per second (i.e., for a period of 1 s). As a result, the controller 101 can acquire ten consecutive pieces of the distance information. The predetermined number of times is set to the number of times required for averaging.

If the number of times of acquisition of the distance information is less than the predetermined number of times, the controller 101 returns to step S401 to acquire the distance information.

On the other hand, if the distance information is acquired the predetermined number of times or more (YES at S402), the controller 101 calculates a temporal average value of the ten acquired pieces of the distance information for each measurement point (S403).

The controller 101 uses the temporal average values of the measurement points calculated at step S403 to detect a position (measurement point) having a large spatial change (S404). Whether the change is large is determined by determining whether a difference between the adjacent measurement points is equal to or greater than a predetermined value.

The controller 101 divides the region of the acquired distance information (distance image) into a plurality of regions (S405). The region of the distance information is divided into a plurality of regions based on the positions having large spatial changes detected at step S404. As a result, the region of the distance information (distance image) can be divided such that the measurement points (pixels) similar in characteristic belong to the same region. For example, the region is appropriately divided such that the measurement points at similar distance are included in the same region based on the measurement points having large changes.

The controller 101 calculates an average value of the distance information of the measurement points for each of minute regions in each of the divided regions (S406). The minute region is a region which is acquired by dividing the divided region and is smaller than the divided region. A spatial average value in each minute region is calculated for each of the minute regions by using the temporally averaged values of the distance information calculated at step S403.

In each of the minute regions, the controller 101 replaces the values of the distance information of the measurement points with the average value in each minute region calculated at step S406 (S407). The distance information after the replacement is used for the subsequent processes.

The control described above can temporally and spatially suppress the measurement variations in the distance information of the distance sensor 103. As a result, the malfunction due to the measurement variations can be suppressed and the operation unintended by a user can be prevented from occurring.

### (4) Limiting Function for Measurement Range of Distance Sensor 103

The limiting function of limiting a range of the measurement by the distance sensor 103 will be described with reference to the drawings. This limiting function is performed at steps S202 and S208.

The region requiring the measurement by the distance sensor 103 is a region for detecting a user operation. The region for detecting a user operation includes a region on which the UI image is projected that is an object to be operated by a user, such as icons and buttons. To enable detection of a user operation even if the operation is performed in the periphery of the region on which the UI image is projected, the region required for detection of the user operation also includes a region around the region in which the UI image is projected. Therefore, as shown in FIG. 4, the region for detecting the user operation is the region 51 including both the region on which the UI image is projected and the periphery region thereof in the region (range) 50 that can be measured by the distance sensor 103. The region (range) 51 for detecting the user operation is referred to as a “measurement target range (region)”.

As the region for detecting the user operation is larger, the probability of occurrence of false detection in the distance information more increases, resulting in higher risk of a malfunction unintended by a user.

Therefore, in the present embodiment, a value of the distance information detected in a range other than the range necessary for detecting the user operation (the measurement target range (region) 51) is replaced with a value indicative of invalidity. As a result, the false detection is reduced.

FIG. 7 is a flowchart for explaining the control for limiting the area of acquisition of data from the distance sensor 103 to an area within the measurement target range.

The controller 101 acquires the distance information from the distance sensor 103 (S501).

The controller 101 determines whether processes of steps S503 and S504 described later are executed for each of the measurement points (pixels) included in the distance information acquired from the distance sensor 103 (S502). When the processes are completed for all the measurement points (pixels) (YES at step S502), the controller 101 terminates this process.

On the other hand, when the processes are not completed for all the measurement points (pixels) (NO at step S502), the controller 101 determines whether the distance information of the measurement point to be processed is information measured within the measurement target range (S503). When the distance information is measured within the measurement target range (YES at step S503), the controller 101 goes to step S502. The measurement target range is appropriately set in advance by a designer, and the controller 101 recognizes which region is in the measurement target range.

On the other hand, when the distance information of the measurement point to be processed is not the distance information measured in the measurement target range, the controller 101 replaces a value of the distance information measured out of the measurement target range at step S503 with zero (S504). The replacement value is not limited to zero and may be any value as long as it can be understood that the value indicates an unmeasurable point. For example, the replacement value may be −1. The controller 101 is configured not to use a value of the distance information when the value is the value indicative of the unmeasurable point (e.g., zero). The controller 101 subsequently goes to step S502.

By limiting the measurement area only to the necessary range in the data measured by the distance sensor 103 as described above, the false detection due to the measurement data of the distance sensor 103 in an unnecessary range can be reduced and the occurrence of operation unintended by a user can be reduced. A load of processing for the controller 101 can also be reduced.

(5) Detection Function of Detecting and Invalidating Point that Cannot Stably be Measured by the Distance Sensor 103

Description will be made of the function of detecting and invalidating a point that cannot stably be measured by the distance sensor 103 with reference to the drawings.

For the distance sensor 103, the same measurement point is measurable at certain timing and is unmeasurable at the other timing. Although depending on a kind of the sensor, this is notable in the type of measuring distance with the trigonometry using a random dot pattern etc.

If the subsequent processes are executed regardless of the presence of data that cannot be measured at the timing of data acquisition from the distance sensor 103, accurate detection may become impossible. Therefore, the user operation cannot accurately be reflected, resulting in occurrence of false detection etc.

Thus, at a measurement point at which distance cannot stably be measured, the data may be invalidated in the distance information so that the data is not used. Description will hereinafter be made of the control of detecting and invalidating the measurement point at which distance cannot stably be measured.

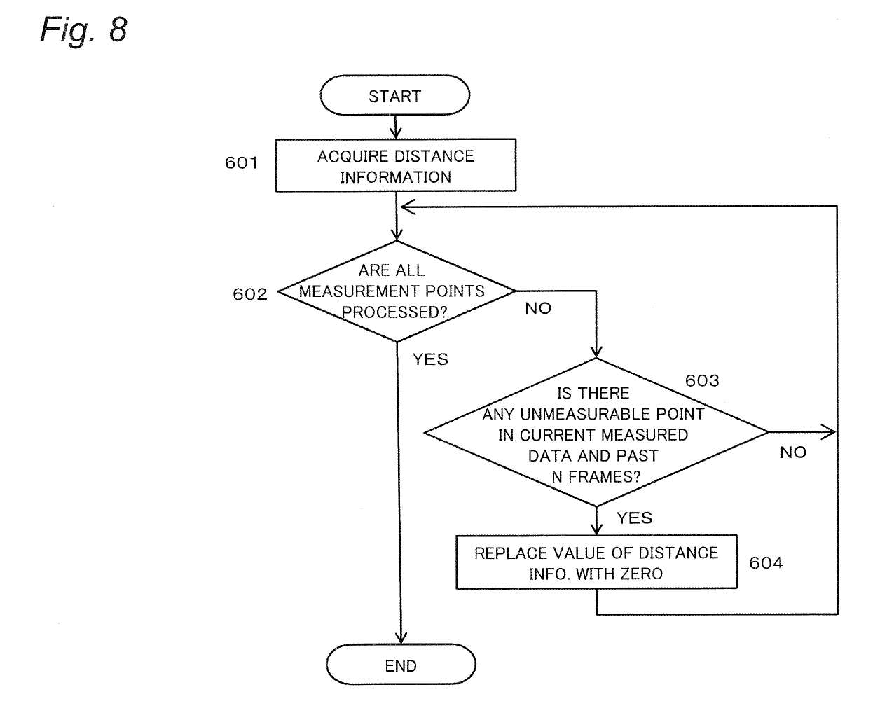

FIG. 8 is a flowchart for explaining the control of detecting and invalidating the measurement point at which distance cannot stably be measured. In this case, data of a less reliable measurement point is invalidated in the distance information (e.g., the value of the measurement point is set to “0” indicative of invalidity). The controller 101 is configured not to use a value of the distance information when the value is the value indicative of invalidity (e.g., zero).

The controller 101 acquires the distance information from the distance sensor 103 (S601).

The controller 101 determines whether processes of steps S603 and S604 described later are executed for each of the measurement points (pixels) included in the distance information acquired from the distance sensor 103 (S602). If the processes are performed for all the measurement points (YES at step S602), the controller 101 terminates this process.

If the processes are not performed for all the measurement points (pixels) (NO at step S502), the controller 101 determines for one measurement point whether the distance information acquired at step S601 and the distance information corresponding to past n frames include unmeasurable information (S603). In particular, the controller 101 determines whether the frame of the distance information acquired this time and the past n frames include a frame having the distance information that could not be measured.

Although whether an unmeasurable frame exists is determined for each piece of the distance information in the configuration described above, the determination may be made for each arbitrary region so as to reduce a process amount.

When it is determined that an unmeasurable frame exists (YES at S603), the controller 101 replaces the value of the distance information in the unmeasurable frame with zero (S604). If any of the current frame and the past n frames is an unmeasurable frame, the point thereof is considered as the point at which the distance cannot stably be measured, and the measured distance is replaced with zero. The replacement value may be an arbitrary value as long as it is understood that the value indicates an unmeasurable point. For example, the replacement value may be −1.

On the other hand, when it is determined that no unmeasurable frame exists (NO at S603), the controller 101 goes to step S602. A shift is made by one measurement point to execute the same process for the next measurement point.

By detecting and invalidating the point that cannot stably be measured by the distance sensor 103 as described above, the distance information to the projection plane 120 can accurately be acquired. Therefore, less reliable data is not used when a reference is made to the distance information of the projection plane 120, and thus the user operation can stably be detected.

The data of the invalidated measurement point can be interpolated and obtained from data of surrounding measurement points. The control shown in FIG. 8 may be combined with the control shown in FIG. 7.

### 3. Effect Etc.

As described above, the projector system 10 of the present embodiment includes the projector 102 (an example of a projector unit) configured to project an image on the projection plane, the distance sensor 103 (an example of an image acquiring unit) configured to capture temporally-continuously an image of a region including the projection plane 120 to generate image information, and the controller 10 configured to calculate distance information that is information on distance to the projection plane 120 based on the image information generated by the distance sensor 103 and performs predetermined control by using the calculated distance information, the controller 10 updating the distance information used for the predetermined control at predetermined timing. With regard to the update of the distance information, the controller 101 calculates information on movement of an object included in the image information from the distance sensor 103 to determine the movement of the object based on the information on movement (S205 and S210 of FIG. 3). When it is determined that the object is not moving, the controller 101 updates the currently set distance information with newly acquired distance information (S208). When it is determined that the object is moving, the controller 101 maintains the currently set distance information as it is without updating the currently set distance information (S207).

With the above configuration, the projector system does not update the distance information when a moving object is detected in the image information used in calculation of the distance information indicative of distance to the projection plane, and updates the distance information only when a moving object is not detected. As a result, it is possible to acquire the distance information that is measured while no object is present between the projector system and the projection plane, so that the accurate distance information on the projection plane can be acquired.

As shown in FIG. 5, the controller 101 may obtain a difference between multiple pieces of the image information (between frames) temporally-continuously generated by the distance sensor 103 after activation (startup) of the distance sensor 103 to determine whether the output of the distance sensor 103 becomes stable based on the difference (S304). The controller 101 may not use the output of the distance sensor 103 for the update of the distance information until it is determined that the output of the distance sensor 103 becomes stable, and may use the output of the distance sensor 103 for the update of the distance information after it is determined that the output of the distance sensor 103 becomes stable (S304, S305).

As shown in FIGS. 6 and 8, the controller 101 may correct a value of the distance information used for the update of the distance information based on multiple pieces of the image information temporally-continuously generated by the distance sensor 103. By correcting the distance information based on temporal change, the measurement variations can be reduced and the malfunction due to the measurement variations can be suppressed.

The controller 101 may spatially smooth the value of the distance information used for the update of the distance information (S406, S407). The spatial smoothing can remove the effect of noises and can improve reliability of data.

For each of the measurement points making up the distance information, when the multiple pieces of the image information temporally-continuously generated by the distance sensor 103 include image information from which the distance information cannot be calculated, the controller 101 may set the value of the distance information related to the measurement point to the value indicative of invalidity (S603, S604). As a result, the value of the distant information can be invalidated for the measurement point that could not be measured in the past, and the trouble due to use of less reliable data can be reduced.

As shown in FIG. 7, the controller 101 may update the information on distance to the projection plane by using only the information related to the region including a predetermined object (e.g., a user interface image) in the distance information (S503, S504). As a result, false detection and malfunction can be reduced and the process load of the controller 101 can be reduced.

### Other Embodiments

As described above, the first embodiment has been described as exemplification of a technique disclosed in this application. However, the technique of this disclosure is not limited thereto and is applicable to embodiments subjected to modification, replacement, addition, and omission as needed. The constituent elements described in the first embodiment can be combined to achieve a new embodiment. Therefore, another embodiment will hereinafter be exemplified.

Although the controller 101 updates the distance information indicative of the distance to the projection plane 120 in predetermined periods according to the flowchart of FIG. 3, the timing of updating the distance information is not limited thereto. The distance information may be updated at arbitrary timing. For example, the distance information may be updated immediately before performing a predetermined operation.

As described above, the embodiments have been described as exemplification of the technique in this disclosure. For this purpose, the accompanying drawings and detailed description have been provided.

Therefore, the constituent elements described in the accompanying drawings and detailed description may include not only the constituent elements essential for solving the problem but also the constituent elements not essential for solving the problem, for exemplification of the technique. Thus, these non-essential elements should not immediately be recognized as being essential because these non-essential elements are described in the accompanying drawings and detailed description.

The embodiments are for the purpose of exemplification of the technique in this disclosure and therefore can be subjected to various modifications, replacements, additions, and omissions within the scope of claims or the scope equivalent thereto.

### INDUSTRIAL APPLICABILITY

In this disclosure, the presence/absence of update of distance information to a projection plane is switched based on detection of movement of an object between the projection plane and a system. This enables accurate acquisition of the distance information to the projection plane. This disclosure is applicable to a projector system measuring a distance to a projection plane and providing control by using a result of the measurement.

1. A projector system comprising:
a projector unit configured to project an image on a projection plane;
an image acquiring unit configured to temporally-continuously capture an image of a region including the projection plane to generate image information; and
a controller configured to calculate distance information that is information on distance to the projection plane based on the image information generated by the image acquiring unit and performs predetermined control by using the calculated distance information, the controller updating the distance information used for the predetermined control at predetermined timing, wherein
with regard to update of the distance information, the controller calculates information on movement of an object included in the image information from the image acquiring unit to determine movement of the object based on the information on movement, wherein
1) when it is determined that the object is not moving, the controller updates the currently set distance information with newly acquired distance information, and wherein
2) when it is determined that the object is moving, the controller maintains the currently set distance information as it is without updating the currently set distance information.

2. The projector system according to claim 1, wherein
the controller obtains a difference between multiple pieces of the image information temporally-continuously generated by the image acquiring unit after activation of the image acquiring unit, and determines whether output of the image acquiring unit becomes stable based on the difference, and
the controller does not use the output of the image acquiring unit for update of the distance information until it is determined that the output of the image acquiring unit becomes stable, and uses the output of the image acquiring unit for update of the distance information after it is determined that the output of the image acquiring unit becomes stable.

3. The projector system according to claim 1, wherein the controller corrects a value of the distance information to be used for update of the distance information, based on multiple pieces of image information temporally-continuously generated by the image acquiring unit.

4. The projector system according to claim 3, wherein the controller further spatially smooths a value of the distance information to be used for update of the distance information.

5. The projector system according to claim 3, wherein
for each of measurement points making up the distance information, when the multiple pieces of the image information temporally-continuously generated by the image acquiring unit include image information from which the distance information cannot be calculated, the controller sets a value of the distance information related to the measurement point to a value indicative of invalidity.

6. The projector system of claim 1, wherein
the controller updates the information on distance to the projection plane by using only the information which is generated by the image acquiring unit and is related to distance measured in a region in which a predetermined object is projected.
